(19) United States
(12) Patent Application Publication
(10) Pub. No.: US 2015/0195589 A1
(43) Pub. Date: Jul. 9, 2015

(54) METHOD OF AND APPARATUS FOR DETERMINING A COMPOSITE VIDEO SERVICES STREAM

(71) Applicants: Richard Anthony Jones, Southampton (GB); Matthew Goldman, Bedford, NH (US)

(72) Inventors: Richard Anthony Jones, Southampton (GB); Matthew Goldman, Bedford, NH (US)

(73) Assignee: Telefonaktiebolaget L M Ericsson (PUBL), Stockholm (SE)

(21) Appl. No.: 14/415,118

(22) PCT Filed: Jul. 16, 2012
(86) PCT No.: PCT/EP2012/063912

§ 371 Date: Jan. 15, 2015

(51) Int. Cl. H04N 21/238; H04N 21/2389; H04N 21/61; H04N 21/258; H04N 21/262; H04N 21/845; H04N 21/2343; H04N 21/24

(52) U.S. Cl. CPC H04N 21/23805; H04N 21/2343; H04N 21/238; H04N 21/2389; H04N 21/2402; H04N 21/258; H04N 21/26216; H04N 21/8456; H04N 21/6125; H04N 21/6175

(57) ABSTRACT

The invention relates to a method of and apparatus for determining a composite video services stream comprising one or more video services for delivery across a digital subscriber loop. In some embodiments, the invention relates to a method of and apparatus for receiving a video service representation in a video services representation stream.

### TECHNICAL FIELD

The invention relates to a method of and apparatus for determining a composite video services stream comprising one or more video services for delivery across a digital subscriber loop. In some embodiments, the invention relates to a method of and apparatus for receiving a video service representation in a video services representation stream.

### BACKGROUND

Traditional telecommunications systems have evolved rapidly in recent years to encompass considerably more capability than simple delivery of a telephony service. Internet technology based on data packets and associated transmission protocols, for example the Internet Protocol (IP), has now superseded the old space switching techniques and dedicated transmission resources during a telephone call or data transmission session.

The convergence of flexible delivery technologies has enabled services to be mixed in the same physical resource so that for example, in telephony networks, subscribers are now able to receive broadcast services as well as access internet resources all via their telephone lines. Previously, the telephone line copper pair was an under-utilized resource that was only used during rare telephone calls. Now the exploitation of this ubiquitous resource has revolutionized the ability of the subscriber to communicate.

A Digital Subscriber Loop (xDSL) modem/router, which is widespread in homes, acts as a common assembly point for all domestic communications traffic whether it be telephony, computer based web browsing, Email, home shopping or streaming of video material of all kinds Various forms of digital subscriber loop are in current use, for example ADSL1, ADSL2, VDSL and other arrangements that offer varying bit rates depending upon telephone wire length. As will be appreciated by a skilled person, the capacity of the digital subscriber loop has to be shared among the services being provided to the subscriber at any particular time.

In Internet Protocol Television (IPTV) systems, each subscriber has their own Digital Subscriber Loop (xDSL) loop, each of which has a different bit rate capacity depending on the physical length of the telephone wire. A subscriber typically has access to voice, data and multiple TV services. Utilization of each of these services will vary by time and subscriber. Additionally, television-type services may be viewed on different device types (exemplified by but not limited to standard definition television (SD-TV), high definition television (HD-TV), tablet computer, personal computer (PC), mobile telephone device, for example), and a different level of quality of service will be appropriate for different types of service and different types of device.

Currently the use of conventional of Internet Protocol (IP) contention for access management in domestic routers is commonplace but leads to difficulties in supporting the needs of the disparate services being carried on the loop. For example high quality video services such as Internet Protocol Television (IPTV) services require a high degree of continuity whereas computer traffic is highly sporadic and can tolerate intermittent transmission. It is undesirable that the quality and continuity of a broadcast service is interrupted by sudden uncontrolled demand by a computer, for example for downloading a large data file. As a result, the usual contention based method of medium access control, typical of Internet Protocol (IP) data transmission, is considered to be inappropriate for access management in domestic routers.

The basic Internet Protocol (IP) can be augmented by other protocols that operate to provide more specific control over the various types of communication being supported by the digital subscriber loop, for example, where file transfer is involved and where more secure transmission is required during the streaming of video material.

There are numerous conventional file transfer solutions. For example, the Hyper-Text Transmission Protocol (HTTP) operates at the Application Layer of the Open Systems Interconnection (OSI) communications model and is in common use for downloading files from servers to clients. These files can be presented in many formats and provide the content of the Hyper-Text Transmission Protocol (HTTP) file with a wrapper of control data that allows management of the file transfer. Video files may be conveyed in this format which allows a certain amount of adaptation control based on available capacity and the data pattern of the downloaded data.

Statistical multiplexing (Statmux) methods have been developed for dealing with the multiplexing of coded video sources with a variable bit rate (VBR) according to the content being coded, rather than being coded at a constant bit rate (CBR). Although this method is very effective in the context of multiplexing, it has practical limitations in general use as a file transfer protocol, especially when the sources to be multiplexed are varied in type and the point of multiplexing is remote.

Alternatively, a constant bit rate (CBR) or a capped variable bit rate (VBR) method is a restricted variant of a full statistical multiplexing (StatMux) method where the bit rates allocated to the components of a composite stream transmitted to a given subscriber are given fixed bit rates, which has a detrimental effect on picture quality. This method is typically used in current delivery systems that comprise a number of video services as well as other services such as internet and telephony for example. This method may also be used with variable bit rate (VBR) coding provided that the maximum bit rate is limited to within a defined range. However, the worst-case scenario must be used when selecting bit rates, and so the quality of the services provided is adversely affected as a result.

The invention seeks to provide a novel method of and apparatus for determining a video services stream comprising one or more video services for delivery across a digital subscriber loop that at least alleviates some problems in the prior art.

The invention seeks to provide a novel method of and apparatus for receiving a video service representation in a video services representation stream that at least alleviates some problems in the prior art.

In some embodiments this invention provides a cost-efficient method to optimize the use of the limited loop capacity to each subscriber.

In particular, some embodiments of the invention enable the limited capacity available to each subscriber in an Internet Protocol (IP) television (IPTV) system based on digital subscriber loop (xDSL) technology operating on a telephone line to be used more efficiently. The capacity requirements are dynamic depending upon the services being used at any particular time.

In embodiments of the invention the disparate requirements of the services whose terminal devices are attached to a domestic network, which may be for example a wired or wireless Ethernet network, are determined in the router terminating the digital subscriber loop (xDSL) line, and shared with an upstream device. These requirements may be expressed for example in terms of the device type, content complexity, quality of service, utilization frequency and intensity.

In embodiments of the invention, therefore, a control mechanism operating at an upstream management system using information provided by the domestic routing device is provided so as to enable the balance of available transmission resource to be judiciously shared among the services. In some embodiments, the balance of transmission resource available can be shared among the services according to their quality of service needs.

### SUMMARY

In accordance with one aspect of the present invention, there is provided a method of determining a composite video services stream comprising one or more video services for delivery across a digital subscriber loop. Each video service is available in a plurality of video service representations each having a different bit rate, the plurality of video service representations of a video service having aligned segment boundaries. In a first step the required video services for delivery across the digital subscriber loop are dynamically determined. In a second step the bandwidth available for delivery of the composite video services stream is dynamically determined. One of the plurality of video service representations of a required video service for delivery across the digital subscriber loop is selected depending on at least the bandwidth available for the composite video services stream.

In some embodiments at least one additional video services information element associated with the video service is used in selecting the video service representation for a video service.

In some embodiments a video services information element relates to the type of device associated with the video service.

In some embodiments a video services information element is a priority information element relating to the priority of the video service.

In some embodiments a higher priority information element is allocated to real-time video services and a lower priority information element is allocated to recorded video services.

In some embodiments the higher priority information element is associated with the video service depending on a categorisation of the video service content or channel.

In some embodiments the video service representation for a video service is selected using quality information elements associated with the video service representations.

In some embodiments the step of dynamically determining the required video services for delivery across the digital subscriber loop comprises receiving information from subscriber apparatus associated with the digital subscriber loop.

In some embodiments the step of dynamically determining the bandwidth available for delivery of the composite video services stream comprises receiving information from subscriber apparatus associated with the digital subscriber loop.

In some embodiments it is determined whether the bandwidth available for delivery of the composite video services is sufficient to provide the required video services for delivery across the digital subscriber loop.

In some embodiments it is determined whether any video service request relates to a non-real-time video service; and if so a non real-time video services stream buffered. The buffered video services stream are transferred at an actual transfer rate that depends on the residual bandwidth available for transfer of the video service representation after bandwidth is allocated to higher priority video services.

In some embodiments real-time video services are of highest priority.

In some embodiments it is determined whether the residual bandwidth is greater than a nominal bit rate of the non real-time video services stream; and in response to a positive determination, the buffer is drained at a faster than real time rate.

In some embodiments a subscriber apparatus is notified of the allocated video representation.

In some embodiments one or more policy elements determined by the subscriber are used in the step of selecting a video services representation.

In some embodiments one or more policy elements determined by an operator are used in the step of selecting a video services representation.

In accordance with a further aspect of the invention there is provided an apparatus for determining a composite video services stream comprising one or more video services for delivery across a digital subscriber loop. Each video service is available in a plurality of video service representations each having a different bit rate, the plurality of video service representations of a video service having aligned segment boundaries. The apparatus comprises representations storage containing video service representation elements relating to the video service representations available. The apparatus comprises video services storage containing requested video services elements relating to the required video services for delivery across the digital subscriber loop. The apparatus comprises available bandwidth storage for storing the bandwidth available for delivery of the composite video services stream. The apparatus comprises a selection element coupled to the representations storage, the video services storage and to the available bandwidth storage, and arranged to select one of the plurality of video service representations of a required video service for delivery across the digital subscriber loop depending on at least the bandwidth available for the composite video services stream.

In some embodiments the apparatus also has policy storage, for storing at least one policy element coupled to the selection element. The selection element uses one or more policy elements to select one of the plurality of video service source representations of a required video service for delivery across the digital subscriber loop.

In accordance with a further aspect of the invention there is provided a method of receiving a video service representation, having a nominal transfer rate, in a video services representation stream. First, a transfer of the video services representation is established. The video services representation is received at an actual transfer rate that may be higher than, or lower than, the nominal transfer rate. The received video services representation is then stored and it is determined whether the end of the video services representation stream has been reached. The transfer is discontinued at the end of the video services representation stream.

In some embodiments the actual transfer rate for a video service representation depends on the residual bandwidth available for transfer of the video service representation after bandwidth is allocated to higher priority video services.

In some embodiments real-time video services are of highest priority.

In accordance with a further aspect of the invention there is provided an apparatus for receiving a video service representation. The apparatus has a communication element arranged to communicate with a video representation source to receive a video services representation stream. In addition, the apparatus has a store, coupled to the communication element to receive a video service representation, in which a received video service representation can be stored. In addition, the apparatus has a control element, coupled to the store to control the writing of video service representation data into the store, and to the communication element in which video services representation is received at an actual transfer rate that may be higher than, or lower than, the nominal transfer rate; wherein the control element is operable to determine the end of the video services representation stream; and to discontinue the transfer at the end of the video services representation stream.

### BRIEF DESCRIPTION OF THE DRAWINGS

The invention will now be described by way of example with reference to the accompanying drawings, in which:

FIG. 1 is a schematic diagram of a typical system for providing services in a real time and Video on Demand (VOD) environment;

FIG. 2 is a schematic diagram corresponding with FIG. 1 showing elements in accordance with embodiments of the invention;

FIG. 3 is a flow chart showing the steps in a method in accordance with an exemplary embodiment of the invention;

FIG. 4 is a schematic block diagram of apparatus elements for implementing embodiments of the invention;

FIG. 5 is a partial schematic diagram of an exemplary embodiment of the invention;

FIG. 6 is a partial schematic diagram of an exemplary embodiment of the invention;

FIG. 7 is a flow chart showing the steps of a method in which video services may be provided to a digital video recorder in accordance with an embodiment of the invention;

FIG. 8 is a graphical representation showing the allocation of loop capacity over a period of time in response to changes in services demanded in an exemplary illustration;

FIG. 9 is a schematic diagram of a digital video recorder in accordance with an exemplary embodiment of the invention; and

FIG. 10 is a flow chart showing steps in a method of receiving a video services representation in accordance with embodiments of the invention.

### DETAILED DESCRIPTION

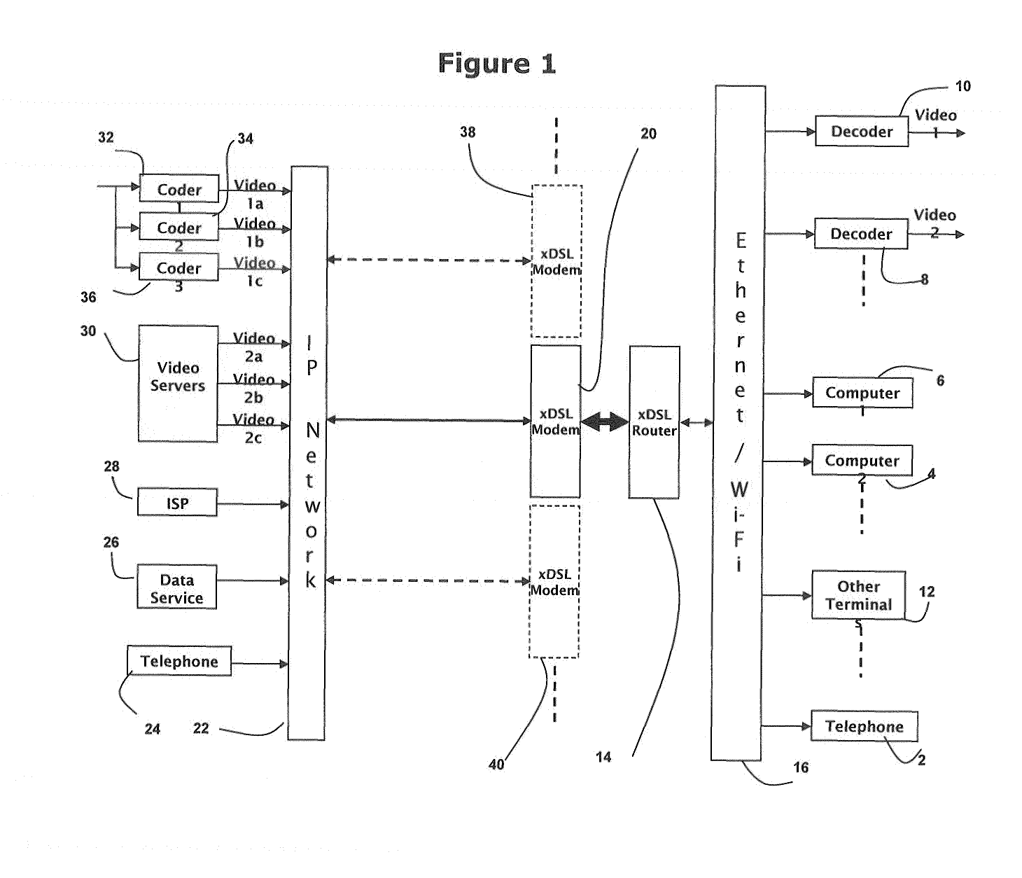

FIG. 1 is a schematic diagram of a typical system for providing services in a Video on Demand (VOD) environment supported by xDSL routers. The various resources shown contribute to the delivery of a group of services to a subscriber over the digital subscriber loop.

At the subscriber side shown on the right hand side of FIG. 1, a number of different devices are present that may require services to be provided over a digital subscriber loop. Typically, such devices may include: a telephone 2; computers 4, 6; video decoders 8 and 10; together with other terminals denoted generically by terminal 12.

These devices 2-12 are coupled to a digital subscriber loop (xDSL) router 14 over a local subscriber network 16, which is typically provided by an Ethernet or by a wireless network.

On the network side shown on the left hand side of FIG. 1, a digital subscriber loop (xDSL) modem 20 is coupled via an Internet Protocol (IP) network 22 to a plurality of service sources 24-36.

The services 24-36 shown at the left are examples of various types of service, all of which may be combined using Internet Protocol (IP) for delivery across the digital subscriber loop to the consumer, where they are separated again for the individual destination devices in the home, as will be understood by a skilled person. The Internet Protocol (IP) infrastructure at the Service Provider end is configured differently on demand for each subscriber, as will be understood by a skilled person, and additional digital subscriber loop (xDSL) modems 38, 40 are shown for completeness.

Two different video service types are shown. In one video service type, the video data is stored as video files in local or distant servers 30. These video files may be transferred in non-real time for later playback at the subscriber's premises or may be watched in real time as if it were live video. Typically, this video service type might be used for a film library that enables a film to be downloaded by a subscriber for immediate viewing or stored for later use.

The stored video files may be for video service recording content accessed in accordance with the requirements of an individual subscriber, for example in accordance with a digital video recorder (DVR) schedule of a subscriber. In some embodiments this non real-time video service content may be deferred by being temporarily buffered in the network when the digital subscriber loop is being heavily utilised, and being moved to the local storage when capacity across the digital subscriber loop becomes available.

A second type of video service type is live video that is delivered in real time but at several different bit rates using a suite of encoders 32, 34, 36. The different bit rates provided by the suite of encoders 32, 34, 36 may reflect different quality levels, for example a high definition (HD) version and a standard definition (SD) version may be provided or the different bit rates may be provided to support a varying capacity in the transmission path. A protocol can be applied to the stream control in order to adapt the bit rate dynamically or to set conditions once for all in the viewing session.

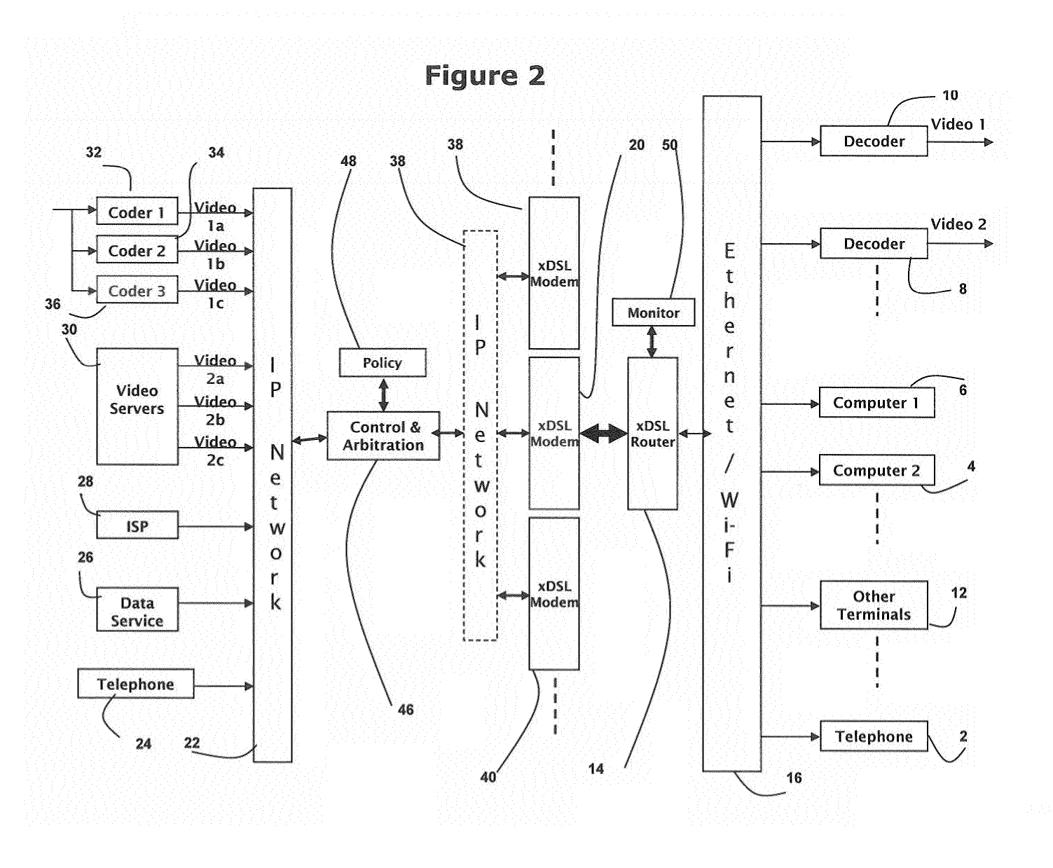

FIG. 2 is a schematic diagram corresponding with FIG. 1 and showing elements that establish some control of the data stream delivered to the destination digital subscriber loop (xDSL) router in accordance with embodiments of the invention. Elements in FIG. 2 having the same or similar function to corresponding elements in FIG. 1 have been given the same reference numerals.

Thus in FIG. 2 a control and arbitration element 46, together with an associated policy element 48, is shown coupled between the modem 20 at the end of the digital subscriber loop and the services 24-36. In addition a monitor element 50 is provided at the subscriber end.

In embodiments of the invention, each video service is made available in a plurality of video service representations, each having a different bit rate. For example in FIG. 2, video service 1 is made available in three video service representations 1a, 1b, 1c and video service 2 is made available in three video service representations 2a, 2b, 2c. In different embodiments and for different video services the number of video services representations available for selection may be greater or less than 3, as decided by a skilled person. The video service representations of a video service have aligned segment boundaries so that their GOP patterns are aligned, as is explained in the following description.

During operation of the exemplary embodiment of the system shown in FIG. 2, the monitor element 50 sends information relating to the video services required and the available loop bandwidth to the control and arbitration element 46. The control and arbitration element 46 uses this information to select an appropriate video representation to effect a dynamic control of the link usage in accordance with embodiments of the invention as will be explained in more detail in the following description.

Dynamic changes in the loading of the transmission channel are accommodated by switching to a video service representation having a higher or a lower rate on demand but taking care that the video decoders remain correctly synchronised and buffer normalization control maintained. Such switching is possible by ensuring that the video coding for the plurality of video service representations for a particular video service is done using Group of Pictures (GOP)s having aligned segment boundaries, as will be explained in the following description.

A basic feature of compressed video data stream syntax is the Group of Pictures (GOP) which comprises a sequence of complete and contiguous video pictures or frames. The Group of Pictures (GOP) begins with a frame selected to be a master frame, denoted as an “I” or Intra Frame for that sequence. This I Frame is coded without reference to any other frame in the sequence and exploits only spatial redundancy within the I frame. Since I frames may be decoded without reference to picture information in any other frame, I frames can be relied upon as a starting point for a decoder.

The other frames or pictures in a Group of Pictures (GOP) can be coded very efficiently by exploiting temporal redundancy in the image sequence. These frames are coded so that information is transmitted describing differences between the current frame and already coded reference frames temporally adjacent to it. Such frames are of two types: one type is a Predicted or P frame type, which is predicted and coded only from one direction of the image sequence, for example from earlier frames in the image sequence. The other type is a Bidirectional frame or B frame type, which are predicted from both forward and backward directions of the sequence, for example by interpolation from earlier and later frames in the video sequence.

As will be appreciated, the success of compression algorithms in achieving low bit rates is because the P and B Frames use smaller amounts of data to encode the picture than an I Frame and are more numerous in a Group of Pictures (GOP). An I Frame uses more data to encode the picture and so these are relatively sparse in a Group of Pictures (GOP). The I frame is very useful when streams are interrupted or suffer occasional errors because it resets the decoder with an independent Frame.

Thus a Group of Pictures (GOP) can be structured as a sequence of I, P and B Frames in an arbitrary pattern e.g. IBBPBBP . . . until the next I Frame is inserted. The length of the Group of Pictures (GOP) will affect coding efficiency because it uses predominantly small coded frame sizes. Such a Group of Pictures (GOP) is known as a Closed Group of Pictures (GOP) because it is self contained and has defined entry points at the I Frame for decoders such that coded pictures following the I frame do not reference any pictures before the I frame. This is useful for this application because the I Frames allow points in a stream at which a bit rate change can be made without necessarily disrupting the decoder.

At the source each TV or video service is supplied in various industry recognized formats and these may be further encoded or transcoded as required. Each service is coded in an array of representations, each at a different Constant Bit Rate (CBR) rate, aligned at segment boundaries, such that the Group of Pictures (GOP) is closed and buffer normalization may be applied. Each of these segments and rates will have an associated quality value. Different methods are well known for determining a quality value for a compressed bit stream, as will be known to a person skilled in the art, and therefore the calculation of the quality values for the different video service representations of a video service will not be discussed in further detail.

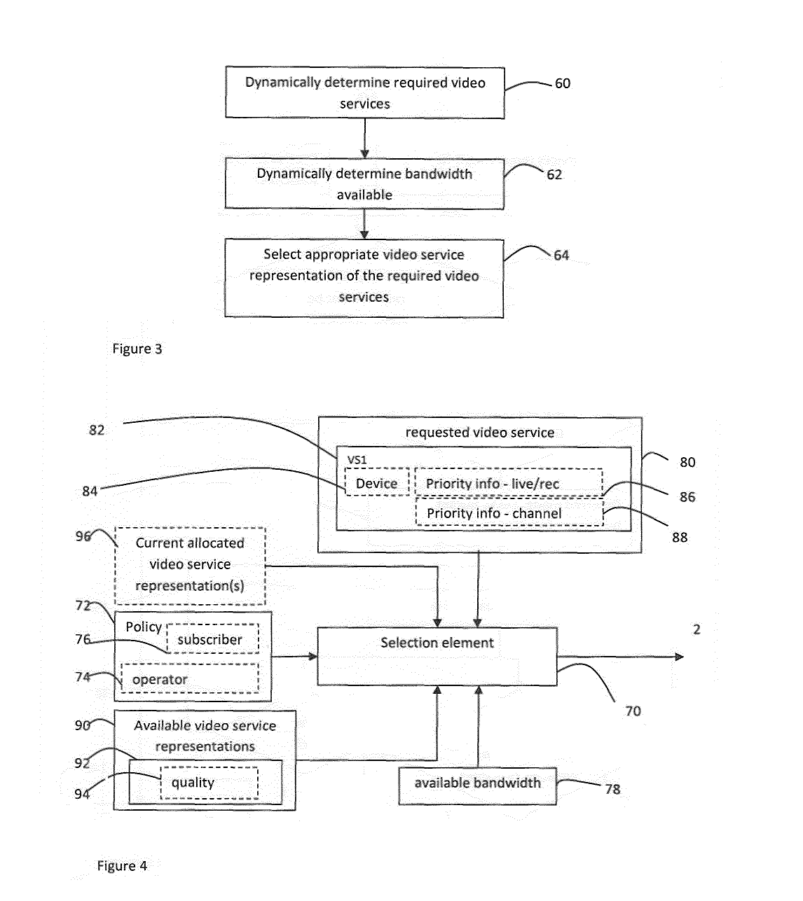

FIG. 3 is a flow chart showing the steps in a method in accordance with an exemplary embodiment of the invention.

In a first step 60 the required video services are dynamically determined. In some embodiments, this step may be carried out by the control and arbitration element 46 receiving required video services information either directly from the monitor element 50 or indirectly from other network elements, such as a D server, involved in providing video services across the subscriber loop.

In a second step, 62, the bandwidth available for transmission of video services across the digital subscriber loop is determined. In some embodiments, this step may be carried out by the control and arbitration element 46 receiving required available bandwidth information from the monitor element 50.

In a third step 64, appropriate video service representations of the required video sources are selected. Typically in some embodiments the control and arbitration element 46 carries out this step. In the exemplary embodiment shown in FIG. 2, the control and arbitration element 46 uses policy information in the policy element 48 to select video service representations.

FIG. 4 is a schematic block diagram of apparatus elements for implementing embodiments of the invention. As will be appreciated by a skilled person, these apparatus elements may be provided in different ways in different embodiments.

A selection element 70 is provided, which is arranged to carry out the selection of the appropriate video service representations as described above with reference to step 64 of FIG. 3 in embodiments of the invention. The selection element 70 typically is implemented in software, although in different embodiments the selection element 70 may be implemented in any manner that seems appropriate to a skilled person. In the embodiment shown in FIG. 2, the selection element 70 is implemented in the control and arbitration element 46.

The selection element 70 is coupled to a policy element 72, which is arranged to provide rules or other information to the selection element 70 in order to facilitate the operation of the selection element 70 to select video service representations. Typically, the policy element 72 will be stored in a memory area that is accessible by the selection element 70 during the selection process. In the embodiment shown in FIG. 2, policy element 72 is implemented in the policy element 48.

In some embodiments the policy element 72 will have some operator policy elements 74 that are selected or determined by a network operator. The network operator may therefore affect the selections of video service representations made by the selection element 70.

In some embodiments the policy element 72 will have some subscriber policy elements 76 that are selected or determined by the subscriber associated with the digital subscriber loop. The subscriber may therefore affect the selections of video service representations made by the selection element 70.

The selection element 70 is coupled to available bandwidth element 78, which specifies the bandwidth available on the digital subscriber loop for video services. Typically, the available bandwidth element 78 will be stored in a memory area that is accessible by the selection element 70 during the selection process. Clearly, during the use of the digital subscriber loop, the bandwidth available for video services will vary depending on the other activity supported by the digital subscriber loop such as the downloading of files by a computer, or email or telephony usage, and therefore in use the available bandwidth element 78 is updated in response to these changes so that the most up to date bandwidth availability is used by the selection element 70 to select video service representations.

The selection element 70 is also coupled to a requested video service element 80 which specifies the video service or video services requested for delivery across the digital subscriber loop. Typically, the available bandwidth element 78 will be stored in a memory area that is accessible by the selection element 70 during the selection process. Clearly, during the use of the digital subscriber loop, the video services requested will vary, and therefore in use the requested video service element 80 is updated in response to these changes.

A single video service VS1 82 is shown in the exemplary embodiment, but clearly in a real embodiment a number of video services maybe required simultaneously.

In some embodiments, further information relating to the requested video services is available, and may be used by the selection element 70 in carrying out the step of selecting a video service representation for delivery across the digital subscriber loop.

In some embodiments, device information 84 relating to the type of device on which the video service is to be viewed, is associated with the video service information VS1 82 and may be used by the selection element 70 in the video service representation selection, for example by selecting a lower bandwidth standard definition video service representation instead of a higher bandwidth high definition video service representation if the video service is to be viewed on a small screen.

In some embodiments priority information relating to the delivery of the video service across the digital subscriber loop may be used by selection element 70 in the step of selecting the video service representation. In some embodiments, the priority information 86 may relate to whether the video service is a video service intended for live viewing, or is being downloaded for later viewing. In this situation the selection element 70 may select a higher bit rate representation for video services for live viewing than those video services that are being downloaded for later viewing. In some embodiments, the priority information 88 relates to the channel on which the video service is being received. Thus, for example, a children's TV channel may be accorded a lower priority than a sports or wildlife programming channel and the channel priority information can be taken into account by the selection element 70 when selecting the video service representations.

The selection element 70 also has access to the available set 90 of video service representations for the video services. Typically, the available set 90 of video service representations for the video services will be stored in a memory area that is accessible by the selection element 70 during the selection process. In some embodiments, a quality rating 92 of each of the representations of a video service is also available to the selection element 70 to be used in the step of selecting a video service representation.

In embodiments of the invention, the selection element 70 also knows the currently allocated video service representations 94. Typically, the currently allocated video service representations 94 will be stored in a memory area that is accessible by the selection element 70 during the selection process.

The particular services that need to be maintained in this environment are the live video ones. The several different video streams that may be delivered to a domestic router at any time vary in attributes depending on their content. In each case, the upstream device has access to a number of alternative coded video streams of the same content, graded by bit rate, and so can uniquely adapt the composite stream delivered to any given subscriber to its total demand as expressed though the local router.

Thus in accordance with embodiments of the invention, where a subscriber is receiving more than one video service, the appropriate set of representations can be chosen in real time using a combination of information elements, examples of which include the following: device capability; service provisioning rules provided by the operator; service provisioning rules provided by the subscriber quality information for the video services representations provided in real time as metadata along with each representation; available capacity on the digital subscriber loop; and voice over IP (VoIP) traffic demand data.

Since all representations of a video service have aligned segments, as discussed above, it is possible to adjust bit rates up and down at the segment boundaries, with due attention to misalignment.

In some embodiments, the selection element 70 may weight TV content against other service types, so that the available group size could itself vary with time based on utilization need.

As an example, if a receive point in the house were to join a service, then, depending on the type of device or display, the category of the channel (e.g. sports vs. children's sports vs. children's programming) and other services currently feeding the household, the representation for each service is selected by a network element that uses the information to form the overall allocation decision. The allocation could furthermore be varied in real time based on information in each service indicating that service's quality vs. bit rate, which varies along with the content itself, resulting in different distributions over time.

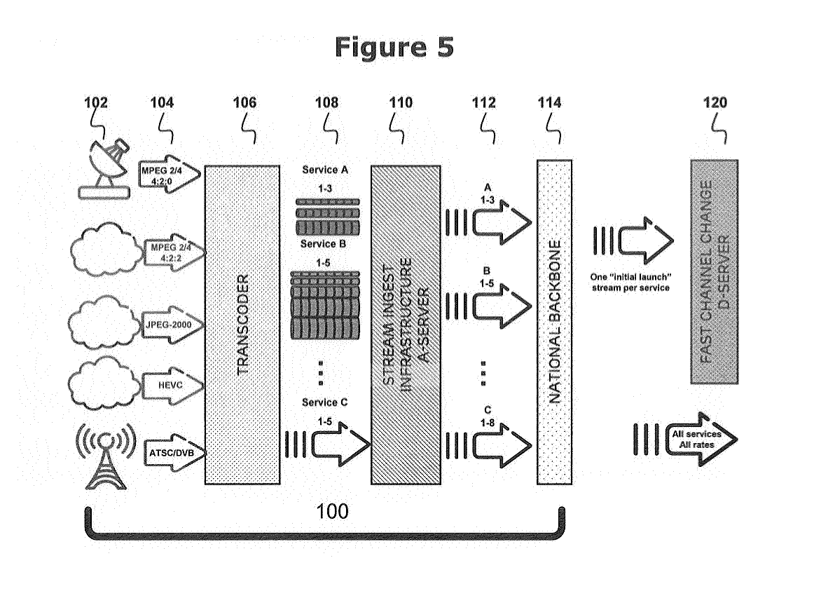

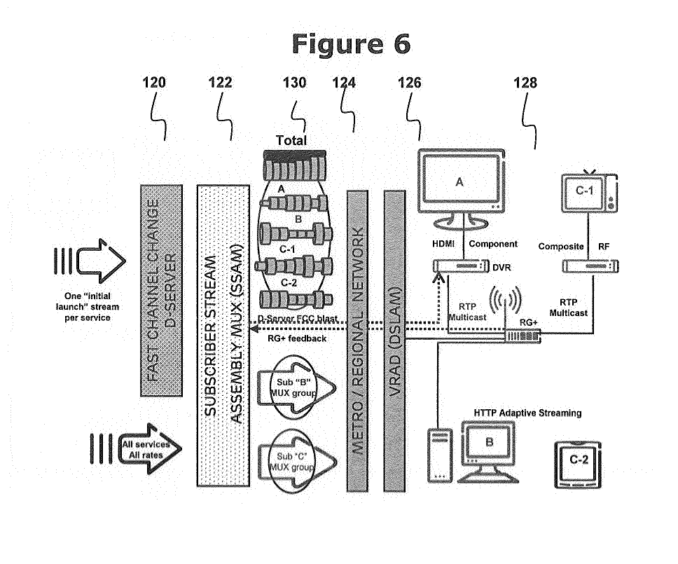

FIGS. 5 and 6 illustrate in more detail an embodiment of the invention where various content streams (labelled A, B and C) are shown being delivered from content vendors/service providers to a multi-terminal subscriber premises.

FIG. 5 illustrates the video aggregation and coding stages that a service provider hosts at a national content centre. Stream segment preparation is shown in section 100.

Content streams are generated and made available from a plurality of different sources 102 in a variety of different compression coding formats 104 as will be understood by a skilled person. This compression coded content is transcoded at 106 to a number of Group of pictures (GOP) synchronized multi-rate multicast streams 108, shown for exemplary services A, B and C in FIG. 5.

These multicast streams 108 are assembled at an A Server 110 into sets of multicast segments 112 coded at different bit rates. These sets of multicast segments 112 are sent into a global or national network 114 for delivery to intermediate nodes where further preparation takes place to adapt the streams to the needs of individual subscribers and to combine those services that the subscriber has requested.

One such intermediate node is a D-server 120 as will be appreciated by a skilled person. In embodiments of the present invention, the D-server operates in a conventional manner other than channel change requests originate from a Subscriber Stream Assembly multiplexer (SSAM) 122 acting as a proxy agent for the residential gateway or other subscriber apparatus such as a set top box. After the initial stream join, the Subscriber Stream Assembly multiplexer (SSAM) 122 is able to access different bit rate copies without intervention from the D-server 120.

The Subscriber Stream Assembly multiplexer (SSAM) 122 is responsible for managing the individual subscriber streams and implements embodiments of the invention. Thus the selection element 70 of FIG. 4 and the control and arbitration element 46 of FIG. 2 are implemented in the Subscriber Stream Assembly multiplexer (SSAM) 122 in the exemplary embodiment shown in FIG. 6.

The Subscriber Stream Assembly multiplexer (SSAM) 122 is coupled via a metro or regional network 124 and VRAD (DSLAM) 126 via a digital subscriber loop (not shown in FIG. 6) to the for example a residential gateway and/or Digital Video Recorder (DVR) in the subscriber network 128. The monitor 52 of FIG. 2 is implemented in a residential gateway and/or Digital Video Recorder (DVR) in the subscriber network 128 in the exemplary embodiment shown in FIG. 6.

During operation of the arrangement shown in FIG. 6, the residential gateway sends dynamic video partition capacity, channel selection, device type and other feedback to the Subscriber Stream Assembly multiplexer (SSAM) 122. The residential gateway also fragments linear streams for HTTP adaptive streaming to all non-set-top box devices. In addition, the residential gateway will de-multiplex the multi-protocol transport stream (MPTS) if used.

The Subscriber Stream Assembly multiplexer (SSAM) 122 uses the information received from the from the residential gateway to select dynamically an appropriate video service representation so as to assemble a video services stream multiplex group for the digital subscriber loop from the available multi-rate inputs. In embodiments of the invention the aggregate bit-rate of the multiplex group will match the available bandwidth of the loop's video partition and will optimize video quality on a device and service priority basis.

The metro or regional network 124 delivers a single-program transport stream/real-time transport protocol (SPTS/RTP) per subscriber per active service or multi-protocol transport stream/real-time transport protocol (MPTS/RTP) per subscriber containing all active streams. In either case these real-time transport protocol (RTP) stream(s) can be multicast or unicast.

FIG. 6 shows diagrammatically the variations in bit rate that adapt services for an individual subscriber by the thickness of the notional data pipeline. The profile of these variations will be different for each subscriber. Thus service A for example will be made available in 3 bit rates, service B in 5 bit rates and service C in 3 bit rates the video services selection will be performed dynamically from these as appropriate to each subscriber loop conditions and loading.

FIG. 6 illustrates a particular state 130 of the downstream xDSL multiplex for a given set of content streams over a specific period of time. The services included in the stream are notional examples (A, B and C) of known service providers. The diameters of the pipelines shown diagrammatically reflect the bit rate allocated to each service over a particular time period during which it can be seen that some services terminate and others begin causing a change in the distribution of capacity. This distribution is managed using the principles of the invention.

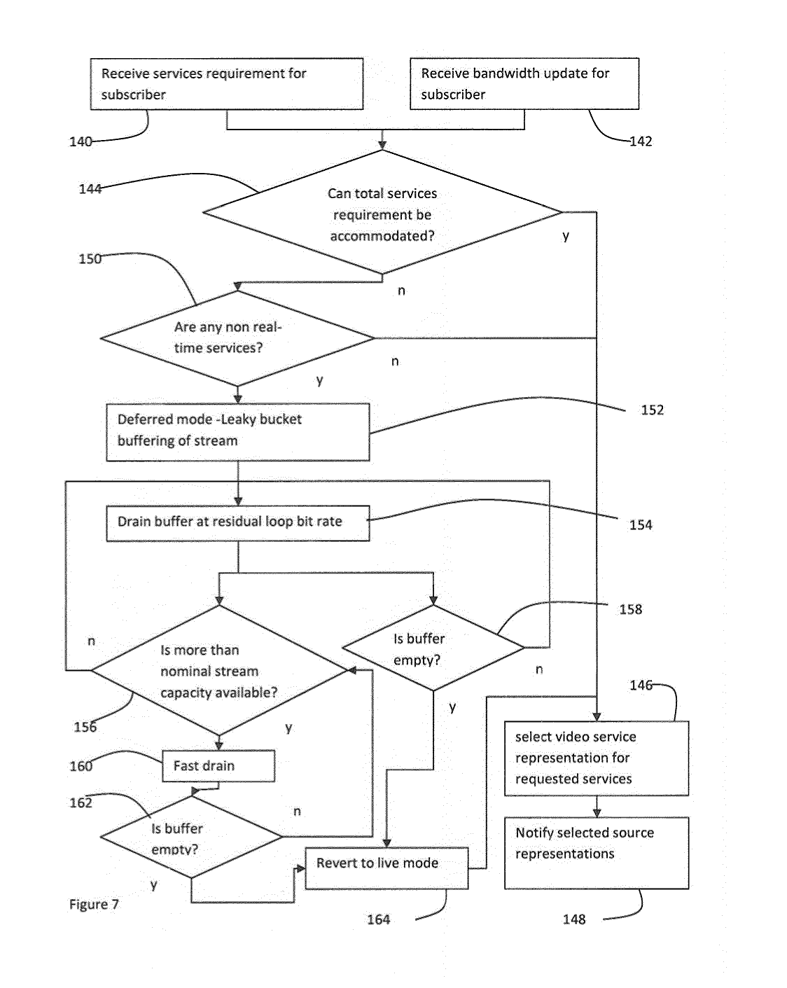

Embodiments of the invention provide support for a subscriber Digital Video Recorder (DVR) recording function that will now be explained with reference to FIG. 7. A video service being recorded by a Digital Video Recorder (DVR) is shown to be varying in bit rate depending on the activity in the multiplex group and so requires management system features to avoid conflicts. Unlike the live video streams, this stream may operate in non real time.

When a Digital Video Recorder (DVR) scheduled event is triggered an appropriate DVR service joins the multiplex group. The Subscriber Stream Assembly Multiplexer (SSAM) 122 recognizes as a special case the request for a new service from the local Digital Video Recorder (DVR) and evaluates the currently available loop capacity differently.

If there is sufficient capacity in the digital subscriber loop to accommodate the video service requested by the digital video recorder (DVR) the Subscriber Stream Assembly Multiplexer (SSAM) 122 selects the requested video service to be made available in real time at its nominal bit rate in a “live mode” of operation.

If there is insufficient capacity in the digital subscriber loop to accommodate the video service requested by the digital video recorder (DVR) the requested video service is placed into “deferred mode” by the Subscriber Stream Assembly Multiplexer (SSAM) 122 where a non real time bit rate is applied.

In the deferred mode, a “leaky bucket” buffering of the video service stream is initiated in order to maintain buffer integrity. The buffer is drained and the video service is transferred at a residual bit rate available on the digital subscriber loop, which will be less than the nominal bit rate of the video service.

In this context, the nominal bit rate or nominal transfer rate of a video service is the transfer rate suitable for real-time viewing of the video service. Typically this means that the compressed video content is delivered to the decoder at a rate that allows the decoder to produce a series of decoded pictures at the appropriate frame rate in continuous operation without dropping or repeating pictures.

The residual bit rate or residual capacity of a digital subscriber loop is the bit rate capacity remaining after the digital subscriber loop capacity has been allocated to other services.

If the buffer acting as the leaky bucket is empty and digital subscriber loop capacity at nominal rate becomes available then the stream reverts to a live operation mode at nominal bit rate of the video service.

If the residual capacity of the digital subscriber loop exceeds the nominal stream capacity of the video service, then the buffer acting as the “leaky bucket” may enter a fast drain mode in which the bucket is emptied, i.e. the buffered video service representation is sent, at an actual transfer rate that is faster than nominal rate. Once the buffer has been drained, the video service representation can be transferred at the nominal rate in the live operation mode at nominal rate.

If a new device attempts to start viewing and a digital video recorder (DVR) recording is in progress, in embodiments of the invention the “live/deferred” status of all recordings is re-evaluated in order to liberate capacity for live viewing.

FIG. 7 is a flow chart showing the steps of a method in which video services may be provided to a digital video recorder in accordance with an embodiment of the invention. This method may be implemented in a Subscriber Stream Assembly Multiplexer (SSAM) 122 as described above with reference to FIG. 6.

In response to a change in either the video services requirement step 140 or the bandwidth available in step 142, it is determined in step 144 whether the total bandwidth required by the video service representations can be accommodated in the available bandwidth.

If so, step 144-y, in step 146 a video service representation for the requested service is selected as discussed above. In step 148, the selected video service representation are notified, for example by sending an initial unicast burst and then sending a message to a subscriber set top box as to which multicast stream should be joined.

If the video services total bandwidth requirement cannot be accommodated in the available bandwidth, step 144-n, it is determined whether any services are being requested by a digital video recorder (DVR) in step 150. If not, step 150-n, the video services representations are selected in step 146 as previously described.

However, if services are requested by a digital video recorder (DVR), step 150-y the video service enters a deferred mode. In the deferred mode the video service stream is buffered, step 152 and the buffer is drained at the residual loop bit rate in step 154.

Thereafter, it is determined whether more bandwidth has become available in step 156 and whether the buffer is now empty in step 158.

If no more capacity is available, step 156-n, or the buffer is not empty, the operation returns to step 154 and the video service remains in a deferred mode in which the buffer is drained at a residual bit rate in step 154.

If more bandwidth becomes available, step 156-y, a fast drain mode is entered in step 160 in which the buffer is drained at a faster than real time rate. It is determined whether the buffer is empty in step 162. If so, step 162-y, operation reverts to a live mode step 164 and the video service representations are selected in accordance with the normal operation in step 146.

If the buffer is not empty, step 162-n, the operation returns to step 156 to determine the available stream capacity.

It follows from this flexible operation that the Digital Video Recorder (DVR) device must accept streams at less than or more than nominal rate and that the Digital Video Recorder (DVR) device must stop recording at end of “stream time”, not clock time because the stream may be delivered at a non real time rate.

The subscriber may experience playback delays if attempting to watch during, or shortly after, program recording ends depending on instantaneous drain rate. If the buffer is full, an indication may be sent back to subscriber to stop watching a live stream to enable the recording OR to cancel the recording.

It is noted that the buffer memory could be allocated in several ways, per subscriber, per program, per service for example, and that per subscriber is the probably the most consistent with current subscriber experience. The provision of a buffer per subscriber with multiple in pointers is technically possible (i.e. record multiple programs per subscriber). Moreover, the provision of a buffer shared between subscribers is technically possible (i.e. multiple out pointers). It is noted that buffer sharing nominally offers a bigger buffer per subscriber.

In this embodiment, all play out is from the local disk drive—there is no video on demand (VOD) asset being created or watchable file being created in the network.

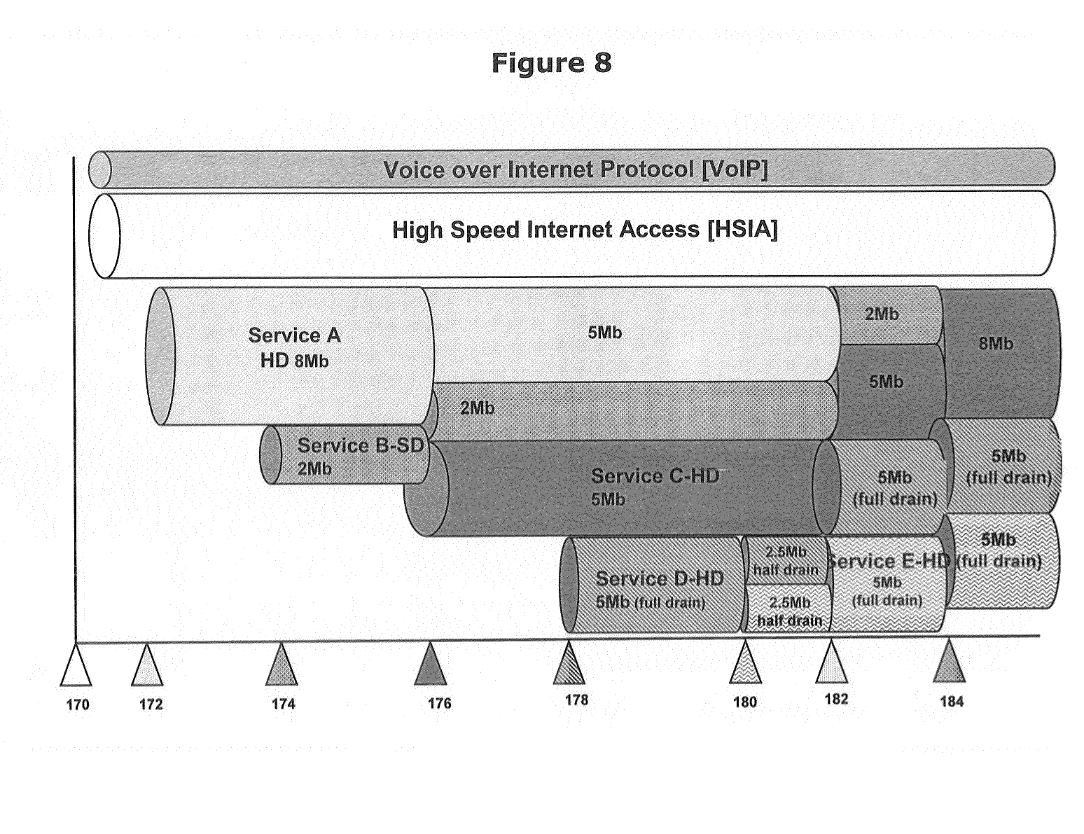

The operation of an exemplary embodiment will now be described with reference to FIG. 8. FIG. 8 is a graphical representation showing the allocation of loop capacity over a period of time in response to changes in services demanded in an exemplary illustration. The horizontal axis in FIG. 8 shows time, while the vertical axis in FIG. 8 indicates video service representations and their bit rates.

The session begins at point 170 with only Voice over Internet Protocol (VoIP) and High Speed Internet Access services in place. The Voice over Internet Protocol (VoIP) and High Speed Internet Access services are permanently available for use on demand and are allocated fixed capacity. At this time there are no video services present.

At point 172 a first video service, Service A, is requested by a member of the subscriber's household and consists, in this example, of a high definition television (HDTV) version of that service initially set to be delivered at 8 Mbps (Mbit per second). It is to be displayed in real time on the main household large screen display device and may be, for example, a live news channel.

This progresses for a short time and then at point 174 another member of the household, possibly located elsewhere, selects Service B which may be, for example, an educational channel and this is provided to a computer terminal at standard definition and initially delivered at 2 Mbps. These services do not cause capacity conflicts and so are able to be delivered simultaneously. The appropriate segment capacity level from those available so that the service qualities requested can be delivered.

At point 176 some time later, the two existing services are joined by a third service, Service C, requested by yet another household member and which may be for example in the exemplary embodiment a sports channel requested in high definition (HD). The sum of the service requirements of the three services A, B and C now exceeds the subscriber loop capacity, and so some adaptation is necessary according to the invention.

In the exemplary embodiment this adaptation results in the selection of video services representations for the high definition (HD) services A and C having a bit rate of 5 Mbps. The bit rate of the video service representation selected for Service B remains unchanged at 2 Mbps.

This situation remains in place for some time further until at point 178 a pre-set recording function is initiated by the domestic Digital Video Recorder (DVR) device. The content required is service D in high definition (HD), which is to be delivered in real time at 5 Mbps. This set of capacities is within the loop capacity, and as a result the high definition (HD) video services representation is selected.

Shortly after this at point 180 another pre-set recording request for service E is initiated and this demand requires a change in the bit rates of the existing services. This is managed using the resources of the invention so that services A, B and C being live TV services do not change bit rates and the new service is accommodated by selecting new video services representations for the DVR services so as to reduce the bit rates for the two to 2.5 Mbps which means, if the quality criteria are retained, that the content will be delivered at half speed taking twice as long to complete. This is a reasonable adjustment that balances the live and DVR service requirements.

This combination of services continues for a while until at point 182 service A is terminated making 5 Mbps available. The system chooses to leave real time services unchanged and to allocate this capacity to the DVR channels restoring real time speed delivery at 5 Mbps each. Thus a video services representation with increased bit rate is selected.

It is possible for quality criteria and capacities to be such that a number of DVR events, which may be set up by different household members so that no one is fully aware of the DVR schedule, cannot be satisfied as well as the current real time services being consumed. This may require the system to intervene and issue on screen messages to an appropriate channels warning of the likelihood of the loss of a digital video recording (DVR) event unless some quality criteria are changed so that for example the standard definition (SD) video services representation is selected instead of the High Definition video services representation or a live service is terminated.

Later still at point 184 service B terminates making available a further 2 Mbps. This additionally available bandwidth is used to enhance service C by selecting a video services representation for service C having a higher bit rate.

Embodiments of the invention continue is this fashion seamlessly adjusting capacity allocations so that demand is managed intelligently and always within the loop capacity and always maintaining service quality criteria.

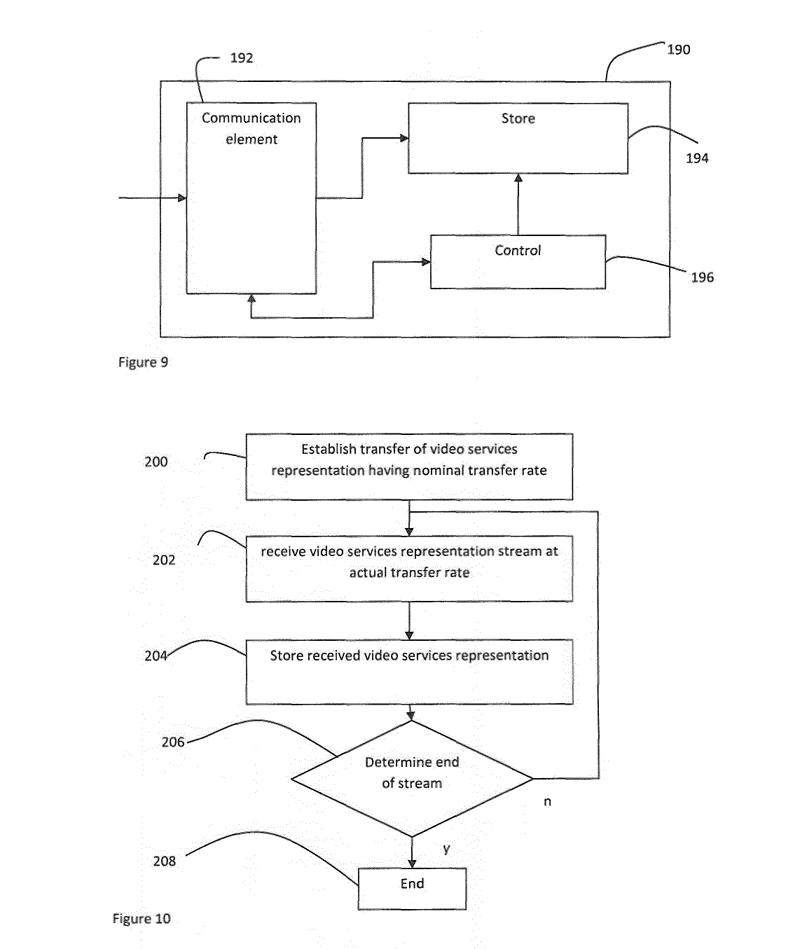

FIG. 9 is a schematic diagram of a digital video recorder 190 in accordance with an exemplary embodiment of the invention.

The exemplary digital video recorder 190 is provided with a communication element 192 arranged to communicate with a video representation source (not shown in FIG. 9) to receive a video services representation stream.

The exemplary digital video recorder 190 is also provided with a store 194 in which a received video service representation can be stored. The store 194 is coupled to the communication element 192 to receive a video service representation.

The exemplary digital video recorder 190 is also provided with a control element 196. The control element is coupled to the store to control the writing of video service representation data into the store 194. In addition, the control element 196 is also coupled to the communication element 192.

FIG. 10 is a flow chart showing steps in a method of receiving a video services representation in accordance with embodiments of the invention.

In a first step 200, the transfer of a video services representation stream is established by the communication element 192 under the control of the control element 196. The establishment of the video services stream may be achieved using techniques familiar to a skilled person.

In a second step 202, the video services representation is obtained at an actual transfer rate from the received video services representation stream by the communication element 192. The video service representation stream may be received at a transfer rate a bit rate that is higher than its nominal bit rate, or at a transfer bit rate lower than its nominal bit rate.

In a third step 204, the received video services representation is stored in the store 194 under the control of the control element 196.

In a fourth step 206, it is determined whether the end of the video services representation stream has been reached. Typically, this step might be carried out by the control element 196 of the exemplary digital video recorder 190 shown in FIG. 9. If the end of the stream has not been reached, step 206-n, the method returns to step 202.

If the end of the stream is reached, step 206-y, the transfer of the video services representation is complete, and the method ends step 208.

Embodiments of the invention enable live television services to be not subjected to contention for limited channel capacity alongside other services that are better able to retain robustness because they are not subject to such strict timing constraints. Where several television services are being delivered along the same path these can be separately regulated.

Embodiments of the invention enable improved utilization of a digital subscriber loop

Embodiments of the invention provide a powerful centralized policy manager that is able to support complex decision logic based on a variety of “weighting factors”. In embodiments of the invention the weighting factors can be easily changed.

Embodiments of the invention provide solutions that enhance the current xDSL streaming and adds a controlled adaption stage that is not supported in ordinary systems of this kind that rely on static distribution of loop bit rate capacity. Embodiments of the invention provide increased video quality by means of multiple stream rates and higher allocated bit rates. In addition embodiments of the invention provide more Streams per subscriber loop requiring stream management and avoidance of stream conflicts. Embodiments of the invention provide greater diversity of subscriber device type for example video quality matched to available decode and display types. Embodiments of the invention provide recording stream deferral allowing flexible operation of the recording device to function with variable bit rates. Given that recording need not be in real time this stream can be adapted more freely than the live video streams that must retain regular continuity

1. A method of determining a composite video services stream, for delivery across a digital subscriber loop, comprising one or more video services, each video service being available in a plurality of video service representations each having a different bit rate, the plurality of video service representations of a video service having aligned segment boundaries, comprising the steps of:
dynamically determining the required video services for delivery across the digital subscriber loop;
dynamically determining the bandwidth available for delivery of the composite video services stream; and
selecting one of the plurality of video service representations of a required video service for delivery across the digital subscriber loop depending on at least the bandwidth available for the composite video services stream.

2. The method as claimed in claim 1, in which the step of selecting the video service representation for a video service uses at least one additional video services information element associated with the video service.

3. The method as claimed in claim 2, in which a video services information element relates to the type of device associated with the video service.

4. The method as claimed in claim 2, in which a video services information element is a priority information element relating to the priority of the video service.

5. The method as claimed in claim 4, in which a higher priority information element is allocated to real-time video services and a lower priority information element is allocated to recorded video services.

6. The method as claimed in claim 4, in which the higher priority information element is associated with the video service depending on a categorisation of the video service content or channel.

7. The method as claimed in claim 1, in which the step of selecting the video service representation for a video service uses quality information elements associated with the video service representations.

8. The method as claimed in claim 1, in which the step of dynamically determining the required video services for delivery across the digital subscriber loop comprises receiving information from subscriber apparatus associated with the digital subscriber loop.

9. The method as claimed in claim 1, in which the step of dynamically determining the bandwidth available for delivery of the composite video services stream comprises receiving information from subscriber apparatus associated with the digital subscriber loop.

10. The method as claimed in claim 1, further comprising the step of determining whether the bandwidth available for delivery of the composite video services is sufficient to provide the required video services for delivery across the digital subscriber loop.

11. The method as claimed in claim 1, further comprising the steps of determining whether any video service request relates to a non-real-time video service; and if so the steps of buffering a non real-time video services stream; and reading the buffered video services stream at an actual transfer rate that depends on the residual bandwidth available for transfer of the video service representation after bandwidth is allocated to higher priority video services.

12. The method as claimed in claim 11, in which real-time video services are of highest priority.

13. The method as claimed in claim 11, further comprising the step of determining that the residual bandwidth is greater than a nominal bit rate of the non real-time video services stream; and in response to a positive determination, the step of fast draining the buffer at a faster than real time rate.

14. The method as claimed in claim 1, further comprising the step of notifying a subscriber apparatus of the allocated video representation.

15. The method as claimed in claim 1, in which the step of selecting uses one or more policy elements determined by the subscriber.

16. The method as claimed in claim 1, in which the step of selecting uses one or more policy elements determined by an operator.

17. An apparatus for determining a composite video services stream, for delivery across a digital subscriber loop, comprising one or more video services, each video service being available in a plurality of video service representations each having a different bit rate, the plurality of video service representations of a video service having aligned segment boundaries, comprising:
a representations store containing video service representation elements relating to the video service representations available;
a video services store containing requested video services elements relating to the required video services for delivery across the digital subscriber loop;
a available bandwidth store for storing the bandwidth available for delivery of the composite video services stream; and
a selection element coupled to the representations store, to the video services store and to the available bandwidth store, and arranged to select one of the plurality of video service representations of a required video service for delivery across the digital subscriber loop depending on at least the bandwidth available for the composite video services stream.

18. The apparatus as claimed in claim 17, further comprising a policy store, for storing one or more policy element coupled to the selection element, wherein the selection element uses one or more policy elements to select one of the plurality of video service source representations of a required video service for delivery across the digital subscriber loop.

19. A method of receiving a video service representation, having a nominal transfer rate, in a video services representation stream, comprising the steps of:
establishing a transfer of the video services representation;
receiving the video services representation at an actual transfer rate that may be higher than, or lower than, the nominal transfer rate;
storing the received video services representation;
determining the end of the video services representation stream; and
discontinuing the transfer at the end of the video services representation stream.

20. The method as claimed in claim 19, in which the actual transfer rate for a video service representation depends on the residual bandwidth available for transfer of the video service representation after bandwidth is allocated to higher priority video services.

21. The method as claimed in claim 20, in which real-time video services are of highest priority.

22. An apparatus for receiving a video service representation, comprising:
a communication element arranged to communicate with a video representation source to receive a video services representation stream;
a store, coupled to the communication element to receive a video service representation, in which a received video service representation can be stored; and
a control element, coupled to the store to control the writing of video service representation data into the store, and coupled to the communication element in which video services representation is received at an actual transfer rate that may be higher than, or lower than, the nominal transfer rate; wherein the control element is operable to determine the end of the video services representation stream; and to discontinue the transfer at the end of the video services representation stream.
